(19) United States
(12) Patent Application Publication
(10) Pub. No.: US 2010/0164388 A1
(43) Pub. Date: Jul. 1, 2010

(54) LUMINOUS SYSTEM AND METHOD WITH A CHANGEABLE COLOR LIGHT

(75) Inventors: Er-Hao CHEN, Tucheng City (TW); Tao-Cheng Yen, Sanchong City (TW); Yi-Ping Hsu, Jhonge City (TW); Chung-Hao Yeh, Taipei City (TW)

Correspondence Address: RABIN & Berdo, PC, 1101 14TH STREET, NW, SUITE 500, WASHINGTON, DC, 20005, US

(73) Assignees: SILITEK ELECTRONIC (GUANGZHOU) CO., LTD., Guangzhou (CN); LITE-ON TECHONOLGY CORPORATION, Taipei City (TW)

(21) Appl. No.: 12/471,679

(22) Filed: May 26, 2009

(30) Foreign Application Priority Data
Dec. 25, 2008 (CN) 200810220595.6

(51) Int. Cl. H05B 41/36

(52) U.S. Cl. 315/151

(57) ABSTRACT

A luminous system with a changeable color light applicable to an electronic device is provided. The system includes a light emitter for emitting a first light to outside of the electronic device, a color sensor for receiving a second light that is the reflection of the first light from an object and generating a RGB signal, and a central controller for receiving the RGB signal and generating a backlight color adjusting signal according to the RGB signal received. A backlight driver module of the device is further introduced to drive a backlight module to emit a third light according to the adjusting signal. The color of the third light is particularly the same as the second light. Thus the backlight color of the electronic device changes as what the color of the object is. The visual effect of the product can be alternative by providing this changeable color light.

### BACKGROUND OF THE INVENTION

1. Field of the Invention

The present invention relates to a luminous system and method, in particular, to a system capable of changing an electronic device's backlight color and the method thereof.

2. Description of Related Art

As technologies keep developing, the appearance design of electronic devices, such as mice or keyboards, also comes to a great diversity. Appearances of products have been taken into more consideration other than the functional improvements. For example, a luminous mouse or keyboard surely gains more visual attraction and has more market potential than that without luminosity.

Generally, the color of conventional electronic device with lighting is unchangeable, providing backlight with single color. The visual attraction of backlight for users decreases soon and users easily feel bored since the backlight color can't be changed as users wish.

Therefore, it is necessary to provide a luminous system capable of changing an electronic device's backlight color, in order to make the device interesting.

### SUMMARY OF THE INVENTION

The objective of the present invention is to provide a luminous system and method allowing users changing the electronic devices' backlight at will. Particularly, the backlight colors can turn into the color reflected from an object's surface. Thus the product's visual impression increases through the changeable colorful backlight.

According to one embodiment, the luminous system with changeable backlight color is provided for an electronic device. The system includes a light emitter for emitting a first light to the outside of the electronic device. Further, the system includes a color sensor for receiving a second light that is the reflection of the first light reflected from a surface of an object, and generating a RGB signal. Furthermore, a central controller is provided for receiving the RGB signal sent from the color sensor, and then generating a backlight color adjusting signal based on the RGB signal. So that a backlight driver module of the electronic device would drive a backlight module to emit a third light according to the backlight color adjusting signal.

The color of the first light can be white or any predetermined color other than white. When the first light color is white, the color of the second light is the intrinsic color reflected from the object's surface. On the other hand, when the first light color is the predetermined color, the color of the second light is tending to the predetermined color on the basis of the intrinsic color of the surface.

In another embodiment of the invention, the system further includes a control key connected with the central controller. The central controller receives an activating signal sent from the control key, and controls the color sensor to receive the second light according to the activating signal. Thus the controller makes the luminous system change the backlight color into the intrinsic color reflected from the object's surface. Thereby, the backlight color of the electronic device can be changed at users' will.

According to one of the embodiments, a method for changing backlight color made by the luminous system is applicable to an electronic device The method includes a first step of emitting a first light, and the next step of forming a second light by reflecting the first light from a surface of an object. After receiving the second light by a color sensor, the method generates a RGB signal. Next, the method has a step of analyzing a primary-color assignment of the RGB signal and generating a backlight color adjusting signal based on the analysis. Consequently, the method goes to drive a backlight module to emit a third light according to the primary-color assignment within the backlight color adjusting signal.

The present invention still provides more approaches to control the changes of the electronic device' backlight color by manipulating a control key based on a user's request, or by performing a program routine set in a host system.

The luminous system and the method of the present invention particularly advances beyond the conventional restriction since it provides a scheme of changeable backlight. In which, the present invention detects a surface color of an object (e.g. desk or mouse pad) via emitting white light on the surface, and uses a color sensor to generate the RGB signal. After that, the invention transfers the signal to the central controller for recognizing the color of the object's surface in order to change the backlight color in accordance with the surface's intrinsic color of different objects. Therefore, the invention provides colorful visual impression of the electronic device, and improves the appearance and the visual attraction of the device.

Detailed description combined with drawings is disclosed below for further understanding of the present invention.

### BRIEF DESCRIPTION OF THE DRAWINGS

FIG. 1 is a functional block diagram for the first embodiment of the luminous system according to the present invention;

FIG. 2 is a functional block diagram for the second embodiment of the system according to the present invention; and

FIG. 3 is a functional block diagram for the third embodiment of the system according to the present invention.

### DETAILED DESCRIPTION OF THE PREFERRED EMBODIMENTS

The aforementioned and the rest of the technical characteristics of the present invention are clearly disclosed in the following description of a preferred embodiment and referred drawings.

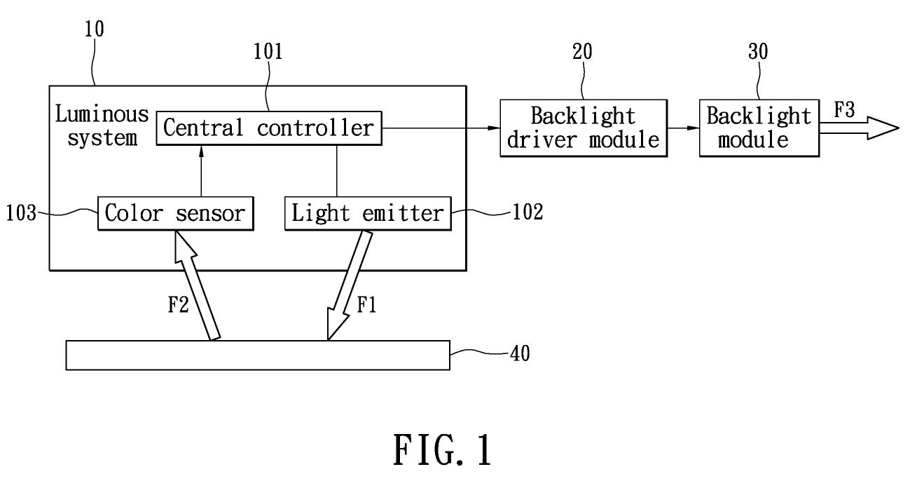

FIG. 1 shows the first embodiment according to the present invention of a luminous system 10 with changeable backlight color. The system 10 is particularly applicable to an electronic device. The system includes a central controller 101, a light emitter 102 and a color sensor 103 electronically connected with the central controller 101 respectively. The light emitter 102 is used for emitting a first light F1 outward from the electronic device, and the first light F1 is preferably a white light. The color sensor 103 is used for receiving a second light F2 which is the reflection of the first light F1 reflected from a surface of an object 40 and then generating a RGB signal according to the second light F2. The color of second light F2 is preferably the same as the surface's intrinsic color of the object 40. The central controller 101 is used for receiving the RGB signal generated and sent by the color sensor 103, and generating a backlight color adjusting signal base on the RGB signal. A backlight driver module 20 is activated by the adjusting signal and used to drive a backlight module 30 to emit a third light F3. The third light F3 has the same color as the second light F2.

The luminous system 10 of the first embodiment emits white light outward to a surface of an external object 40. The second light F2 that is received by the color sensor 103 as reflected from the object's 40 surface is with an intrinsic color. The color sensor 103 feeds the RGB signal back to the central controller 101. The central controller 101 determines the color of the surface from the RGB signal, so as to recognize the chromatic aberration between the color of the object's 40 surface and the color previously determined. The backlight module 30 changes the light as it emits according to the control of the central controller 101.

The RGB signal of the embodiment contains a primary-color assignment of light, representing different combination of the three primary colors, red, green, and blue, in a specific light color. In other words, the central controller 101 identifies the color of the second light F2 by analyzing the primary-color assignment within the received RGB signal. The surface color of the object 40 depends on how the object 40 absorbs and reflects lights, and what the reflection coefficient and transmission coefficient are. When white light shines on the object 40, all the wavelengths of colors on the spectrum are absorbed by the object's 40 surface, except for the wavelength of the object's 40 surface color. The surface reflects the light with the same wavelength as the color of the surface to humans' eyes, so that humans could perceive the intrinsic color of the object's 40 surface. Based on the above-mentioned concept, the preferred first light F1 sent by the light emitter 102 in this embodiment is white light. The color sensor 103 captures the light, i.e. the second light F2, with the wavelength of the object's surface color via the light emitter 102 emitting the white light to the object's 40 surface.

The color sensor 103 includes a color filtering program, a photodiode, and a current-to-voltage converter. The color filtering program is capable of filtering out invisible light in the second light F2 reflected from the object's 40 surface. The photo diode is capable of converting the second light F2 into R current, G current, and B current. The current is amplified and converted from light current into analog voltage by the current-to-voltage converter, which forms the RGB signal.

The central controller 101 receives and analyzes the RGB signal transmitted from the color sensor 103, in order to identify the color of the light. The primary color assignment of the RGB signal is analyzed according to the primary color assignment of a previously received light or a predefined reference color, so as to determine the different combination ratio between the RGB signal and the previously received light, or the reference color. The central controller 101 sends the backlight color adjusting signal to the backlight driver module 20 according to the different combination ratio, and activates the backlight driver module 20 to drive the backlight module 30 to emit the third light F3 based on the backlight color adjusting signal. The color of the third light F3 is the same as that of the second light F2. Therefore the luminous system 10 reaches the goal of changing the backlight color of the electronic device as the color of outside environment changes.

There are three backlight driver modules 20, including a red backlight driver module, a green backlight driver module, and a blue backlight driver module, in this embodiment. Each backlight driver module 20 electronically connects with the central controller 101 of the luminous system 10, respectively. The three backlight driver modules are used to adjust the combination ratio of the three primary colors according to the backlight color adjusting signal sent from the central controller 101, and drive the backlight module 30 to output the third light F3.

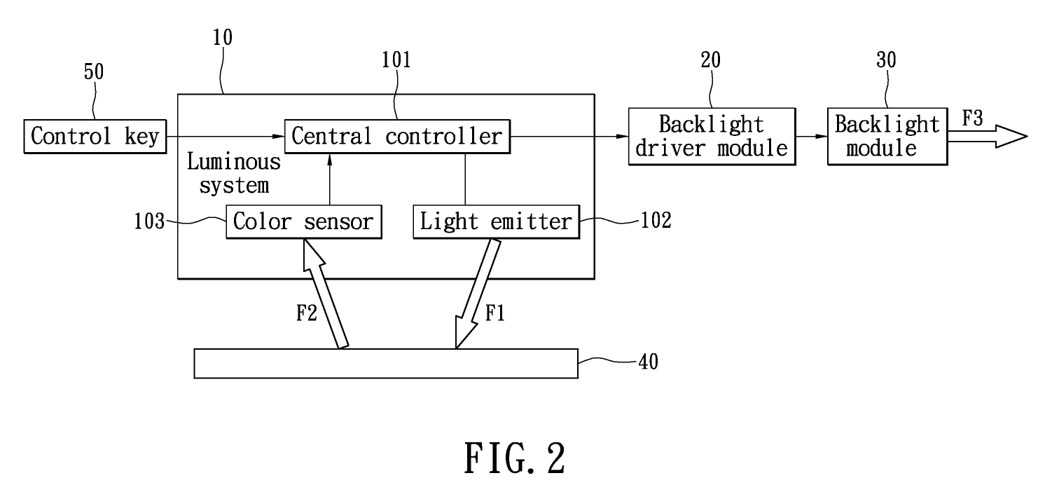

Referring now to FIG. 2, in which a second embodiment of the present invention is shown. The luminous system 10 of this embodiment further includes a control key 50 which electronically connects with the central controller 101. Through manipulating the control key 50, an activating signal is transmitted to the central controller 101. Thus the central controller 101 makes the color sensor 103 start to receive the second light F2 that reflecting from the object 40, so as to emit the third light F3 by the backlight module 30. Particularly the third light F3 is the same as the intrinsic color of the object's 40 surface.

In the second embodiment, a user touches or presses the control key 50 to send a command that demands the luminous system 10 to receive the second light F2. The luminous system 10 then detects the variation of outside environment and changes the backlight color according to the variation.

The difference between the first and the second embodiments is that the luminous system 10 in the first embodiment actively detects the outside environment variations through continuously detecting the reflection of the white light emitted by the light emitter 102, and changes the backlight color of the electronic device based on the color of the object's 40 surface. Meanwhile, the luminous system 10 of second embodiment merely activates the detection for outside environment color and changes the backlight color on the user's demand through controlling the control key 50.

The present invention further provides a method of changing backlight color via a luminous system, which applies to an electronic device. The following are some of the preferred embodiments of the method.

The first embodiment of the method is described as follows:

This embodiment includes the following steps. Firstly, the luminous system 10 controls a light emitter 102 to emit a first light F1 outward the electronic device, wherein the first light F1 is white light. Then the first light F1 is reflected from the surface of an object 40 outside the electronic device, and the reflection forms a second light F2. A color sensor 103 receives the second light F2 and generates a RGB signal according to the second light F2. A central controller 101 of the luminous system 10 receives the RGB signal, and generates a backlight color adjusting signal after analyzing a primary-color assignment of the RGB signal. Finally, a backlight driver module 20 of the luminous system 10 receives the backlight color adjusting signal, and drives a backlight module 30 according to the adjusting signal to emit a third light F3 that has the same color as the second light F2 does.

In the step of emitting the first light F1, when the light emitter 102 is turned on, the light emitter 102 keeps emitting out the first light F1 in white color, which shines at a surface of an object 40 setting outside of the electronic device.

In the step of forming the second light F2 and generating the RGB signal, the first light F1 is reflected from the object's 40 surface. The surface reflects the light with a wavelength that is the same as the color of the surface, which is the second light F2, and absorbs the light with other wavelengths. Color sensor 103 receives the second light F2 within the detection range, and filters out some of the invisible light (such as ultraviolet) of the second light F2 by a color filtering program. A photodiode converts the filtered second light F2 into R current, G current, and B current. After amplifying the R, G, and B current, a current-to-voltage converter converts the light current into analog voltage, which becomes the RGB signal. The RGB signal contains the primary-color assignment of light, which means that different colors correspond to different combination of the primary colors.

In the step of generating the backlight color adjusting signal, the central controller 101 receives the RGB signal, and calculates the RGB value of the RGB signal by a graphic analysis software. The RGB value is compared with the value of a previously received color or a predefined reference color. When the two values are different, the central controller 101 sends the backlight color adjusting signal to the backlight driver module 20, so as to control the backlight driver module 20 and change the backlight color. The backlight color adjusting signal includes the RGB value of the second light F2.

In the step of emitting the third light F3, the backlight driver module 20 controls the backlight module 30 to change the color of the emitted light according to the backlight color adjusting signal. Since the backlight color adjusting signal contains the information of the RGB value of the second light F2, in accordance with the combination of the primary colors, the backlight driver module 20 drives the backlight module 30 to emit the third light F3, wherein the color of the third light F3 is the same as the second light F2.

The color of the second light F2 is the same as the color of the object's 40 surface that emitted by the first light F1 (the white light). Therefore, the third light F3 (i.e. the backlight) emitted by the backlight module 30 is also the same as the color of the object's 40 surface. Hence, the method reaches the goal of changing the backlight color in accordance with the colors variation of the object's 40 surface that emitted by the white light.

The second embodiment of the method is described as follows:

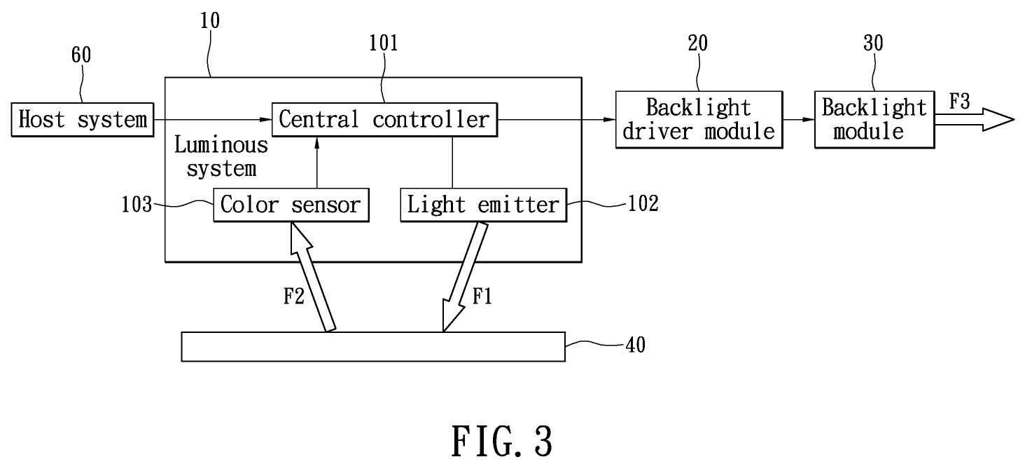

Referring to FIG. 3, the second embodiment further includes a step of sending a control command from a host system 60 to the central controller 101 of the luminous system 10 before emitting the first light F1. In this embodiment, the host system 60 automatically sends the control command via a program installed in the host system 60. The luminous system 10 starts to detect the variation of outside colors after receiving the control command, and adjusts the backlight color according to the variation detected. Other following steps have been described in the first embodiment of the method and the detailed description is omitted here.

Another scheme for controlling the luminous system 10 by the host system 60 is sending the backlight color adjusting signal directly from the host system 60. The central controller 101 of the luminous system 10 receives the adjusting signal directly from the host system 60 and transmits the signal to the backlight driver module 20, in order to drive the backlight module 30 to emit light. Thus the electronic device is capable of illuminating a backlight color that indicated by the host system 60.

The third embodiment of the method is described as follows:

Referring to FIG. 2 again, the method further includes a step of sending an activating signal to the central controller 101 by manipulating a control key 50. After receiving the activating signal demanding the luminous system 10 to adjust the backlight color, the luminous system 10 starts to detect the variation of outside colors and change the backlight color in accordance with the variation. In this embodiment, the luminous system 10 starts the detection and backlight color changing only when the control key 50 is manipulated, such as pressed or touched.

Besides, a cheaper green LED can be used in the light emitter 102 instead of a white LED that is relatively expensive, and to emit green light as the first light F1. The luminous system 10 generates different backlight color adjusting signal that complies with different LED colors. In other words, if the first light F1 color is a predetermined color other than white, the color of the second light F2 will be a color tending to the predetermined color on the basis of the intrinsic color of the object's 40 surface. For example, when the first light F1 is red and the intrinsic color of the object's surface is green, the color of the reflected second light F2 is tending to red on the basis of green. Therefor, the central controller 101 receives the RGB signal from the color sensor 103 and extracts RGB value of the intrinsic color of the surface (i.e. green, in this example) from the predetermined color of the first light F1 (i.e. red, in this example). The backlight color adjusting signal is generated according to the extracted RGB signal.

Furthermore, in consideration of outputting either warm backlight colors or cool backlight colors, the luminous system 10 can emit a warm color light or a cool color light by different LED from light emitter 102, and adjusts the backlight color according to the warm or cool color been emitted without the analysis by the central controller 101.

Moreover, the different predetermined colors of the first light F1 affect the color of the second light F2 in different degrees. Generally speaking, red light affects the color of the second light F2 most, followed by white, green, blue, cyan, and violet in sequence, and etc. Moreover, the color of the second light F2 also depends on the brightness of the first light F1, the distance between the emitted object 40 and other objects around the emitted object 40, and the smoothness and the color of the surface of the emitted object 40. In general, if the distance between the emitted object 40 and other objects around is shorter, the surface of the emitted object 40 is smoother, or the reflection is stronger, the impact of the predetermined color on the color of the emitted object 40 will grow stronger too. On the contrary, if the distance is longer, the surface is rougher, or the intrinsic color of the object 40 is lighter, the impact of the predetermined color of the first light F1 on the object 40 is weaker.

The aforementioned electronic device can be a mouse or a keyboard. Last, the following discloses a specific embodiment of the luminous system and the backlight changing method applying on a mouse.

The mouse includes a central controller installed inside a casing of the mouse, and a light emitter and a color sensor electronically connects with the central controller respectively. The light emitter is installed in the bottom of the casing, for emitting a first light outward the mouse. The first light is white light, and the bottom of the casing is configured with a transparent shelter, wherein the light emitter emits white light through the transparent shelter. In general, the bottom of the mouse is facing a desk or a mouse pad, wherein the white light is emitted to the desk or the mouse pad.

The color sensor is configured to receive a second light F2 that the first light F1 reflects from a surface of an object 40, and generate a RGB signal according to the second light F2. The color of the second light F2 is the same as the intrinsic color of the object's surface, which means the color of the second light F2 the same as the color of the desk or the mouse pad.

The central controller receives the RGB signal transmitted from the color sensor, and generates a backlight color adjusting signal based on the RGB signal, so that a backlight driver module drives a backlight module to emit a third light according to the adjusting signal. The third light has the same color as the second light does. In other words, it has the same color as the desk or the mouse pad dose. Therefore, the backlight color of the mouse keeps changing in accordance with the changing of the desk or the mouse pad, so as to fulfill the requirement of providing colorful visual effect for the electronic device.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A luminous system with changeable backlight colors applicable to an electronic device, comprising:
a light emitter configured to emit a first light from the electronic device;
a color sensor configured to receive a second light and generate a RGB signal, wherein the second light is the reflection of the first light reflected from a surface of an object;
a central controller configured to receive the RGB signal from the color sensor, and generate a backlight color adjusting signal based on the RGB signal;
whereby a backlight driver module of the electronic device is provided to drive a backlight module to emit a third light according to the backlight color adjusting signal.

2. The luminous system according to claim 1, wherein the color of the first light is white, and the color of the second light is an intrinsic color of the object's surface.

3. The luminous system according to claim 1, wherein the color of the first light is a predetermined color, and the color of the second light is tending to the predetermined color on the basis of the intrinsic color of the object's surface.

4. The luminous system according to claim 3, wherein the central controller receives the RGB signal from the color sensor, and extracts an object-RGB signal of the surface's color of the object based on the predetermined color, and then generates the backlight color adjusting signal according to the object-RGB signal.

5. The luminous system according to claim 1, further comprising a control key electronically connected with the central controller, wherein the central controller receives an activating signal from the control key, making the color sensor receive the second light, so as to change the backlight color into the color of the object's surface.

6. A method of changing backlight color via a luminous system, applicable to an electronic device, comprising:
A) emitting a first light;
B) forming a second light by reflecting the first light from a surface of an object, and a color sensor receives the second light and generates an RGB signal;
C) analyzing a primary-color assignment of the RGB signal and generating a backlight color adjusting signal based on the analysis; and
D) driving a backlight module to emit a third light according to the primary-color assignment in response to the backlight color adjusting signal.

7. The method according to claim 6, further comprising: a) a host system transmitting a control command to a central controller of the luminous system, wherein the luminous system proceeds step A) and the following steps according to the control command.

8. The method according to claim 6, further comprising: a′) transmitting an activating signal to a central controller of the luminous system by manipulating a control key, wherein the luminous system proceeds step A) and the following steps according to the activating signal.

9. The method according to claim 6, wherein the first light color is white or a predetermined color other than white.

10. The method according to claim 9, wherein when the first light color is white, the second light is tending to the predetermined color on the basis of the intrinsic color of the object's surface, an object-RGB signal of the surface's color of the object is extracted based on the predetermined color of the first light, and a backlight color adjusting signal is generated according to the object-RGB signal.
